(19) United States
(12) Patent Application Publication
(10) Pub. No.: US 2012/0295108 A1
(43) Pub. Date: Nov. 22, 2012

(54) Carbon Nanostructure

(76) Inventors: Nobuyuki NISHI, Aichi (JP); Kazuhiko MIZUUCHI, Fukuoka (JP); Norikazu ADACHI, Aichi (JP); Yasuyuki OOBA, Aichi (JP)

(21) Appl. No.: 13/564,890

(22) Filed: Aug. 2, 2012

Related U.S. Application Data
(60) Provisional application No. 61/514,577, filed on Aug. 3, 2011.

(30) Foreign Application Priority Data
Feb. 4, 2011 (JP) 2011-022684

(51) Int. Cl. C01B 31/00; H01B 1/04; B32B 9/04; B01J 32/00; B82Y 30/00

(52) U.S. Cl. 428/368; 428/403; 977/734

(57) ABSTRACT

This invention provides a carbon nanostructure including: carbon containing rod-shaped materials and/or carbon containing sheet-shaped materials which are bound three-dimensionally; and graphene multilayer membrane walls which are formed in the rod-shaped materials and/or the sheet-shaped materials; wherein air-sac-like pores, which are defined by the graphene multilayer membrane walls, are formed in the rod-shaped materials and/or the sheet-shaped materials.

### CROSS-REFERENCE TO RELATED APPLICATIONS

This application is based upon and claims the benefit of priority from Japanese Patent Application 2011-022684 and U.S. provisional Patent Application 61/514,577, the entire contents of which are incorporated herein by reference.

### TECHNICAL FIELD

The present invention relates to a carbon nanostructure.

### BACKGROUND ART

Carbon material is applied for a low temperature fuel cell, an electrode of supercapacitor or lithium secondary battery or a catalyst carrier in liquid-phase catalytic reaction. Therefore, the carbon material becomes important more than ever while the cost reduction for the production of the carbon material is more and more required. In the use of the carbon material as the electrode or the catalyst carrier, the high porosity of the carbon material becomes important in view of high fluidity of gas and liquid. In the use of the carbon material as the electrode material, the high electric conductivity and current density of the carbon material becomes important.

As an example using the carbon material as the electrode material, Non-patent document 1 discloses that a silicon-carbon composite material, which is deposited and bonded with the surface of each of carbon particles obtained through the high temperature decomposition of propylene gas by means of CVD (Chemical Vapor Deposition), can exhibit a high capacity retention rate of 1,270 mAh/cm³ even at 20 hours discharging rate (C/20) and exhibits a charge/discharge efficiency of 98% or more even though the silicon-carbon composite material is fixed on the surface of each of the carbon particles. In a high current density region, however, the capacity retention rate decreases remarkably and cannot be maintained stably because the specific surface area of the silicon-carbon composite material is not sufficient and thus the conditions of the spaces of the corresponding voids affect the specific surface area.

Moreover, Patent document 1 teaches the producing technique for the production of a negative electrode of lithium secondary battery by supporting, in the micropores of an activated carbon, an active material such as tin, calcium, strontium, barium and iridium as a metallic material which can form an alloy with lithium. However, the upper limited value of the additive amount of the active material is 30% relative to the mass of the carbon of the activated carbon so that the thus obtained capacity retention rate is not sufficient and the thus obtained charge/discharge efficiency is not sufficient.

As an example using the carbon material as the catalyst carrier, Patent document 2 teaches that catalyst metal (gallium) is introduced into an amorphous carbon structure made of an organic material not containing a metallic material by means of ion beam-excited CVD, and the thus obtained catalyst-introduced amorphous carbon structure is heated at a temperature of about 500° C. so as to eliminate the catalyst from the amorphous carbon structure and obtain the porous carbon structure from the amorphous carbon structure after cooling process, which the porous carbon structure is utilized as a catalyst carrier. However, the porous density of the catalyst carrier is not sufficient so that the catalyst carrier cannot support a large amount of catalyst metal in the case that such an attempt as supporting the catalyst metal is made.

Non patent document 1: High-performance lithium-ion anodes using a hierarchical bottom-up approach, A. Magasinski, P. Dixon, B. Hertzberg, A. Kvit, J. Ayala, and G. Yushin, Nature Materials, 9(2010)353-358
Patent document 1: Japanese Patent No. 4069465
Patent document 2: Japanese Patent publication No. 2009-203128

### DISCLOSURE OF THE INVENTION

### Problem to be Solved by the Invention

It is an object of the present invention to provide a new structural carbon material capable of being used as an electrode material or a catalyst carrier.

### Technical Solution

In order to achieve the object of the present invention, the present invention relates to a carbon nanostructure including: carbon containing rod-shaped materials and/or carbon containing sheet-shaped materials which are bound three-dimensionally; and graphene multilayer membrane walls which are formed in the rod-shaped materials and/or the sheet-shaped materials; wherein air-sac-like pores, which are defined by the graphene multilayer membrane walls, are formed in the rod-shaped materials and/or the sheet-shaped materials.

The carbon nanostructure of the present invention is configured such that carbon-containing rod-shaped materials and/or carbon containing sheet-shaped materials are three-dimensionally bound to each other while air-sac-like pores, which are defined by graphene multilayer membrane walls, are formed in the rod-shaped materials and/or the sheet-shaped materials. By supporting various substances into the air-sac-like pores for any purpose, therefore, the carbon nanostructure can be employed for various uses.

For example, by supporting a metallic material which is reversibly storable with lithium metal in the pores of the carbon nanostructure, the carbon nanostructure can be employed as a negative electrode of a lithium ion secondary battery. Moreover, by supporting a metallic catalyst in the pores of the carbon nanostructure, the carbon nanostructure can be employed as a catalyst carrier.

In the present invention, “nanostructure” is originated from that the characterized constituent components of the intended structure have respective dimensions in the order of several nanometers through several hundred nanometers.

In the present invention, moreover, “air-sac-like pores” means the state where some membrane walls of the graphene multilayer membrane walls defining the pores are branched several times so that the adjacent pores are communicated with one another.

The carbon nanostructure may be formed in any shape, but may be normally formed in a shape of three-dimensional integrated monolith in the case of the use of the producing method as will be described below.

### Advantageous Effect

According to the present invention can be provided a new structural carbon material capable of being used as an electrode material or a catalyst carrier.

### BRIEF DESCRIPTION OF THE DRAWINGS

FIG. 1 is a SEM image showing the appearance of a carbon nanostructure according to the present invention.

FIG. 2 is also a SEM image showing the enlarged surface of the carbon nanostructure in FIG. 1.

FIG. 3 is also a SEM image showing the enlarged surface of the carbon nanostructure in FIG. 1.

FIG. 4 is a SEM image of the rod-shaped crystalline materials and/or the sheet-shaped crystalline materials made of copper methylacetylide.

FIG. 5 is a TEM image of the rod-shaped crystalline materials and/or the sheet-shaped crystalline materials made of copper methylacetylide.

FIG. 6 is a TEM image showing a portion of the carbon nanostructure in FIG. 1.

FIG. 7 is a graph showing the result in TGA (thermogravimetric analysis) of a carbon nanostructure in EXAMPLE.

FIG. 8 is a TEM image showing the carbon nanostructure in EXAMPLE.

FIG. 9 is a graph showing the electron energy loss spectrum of the carbon nanostructure in EXAMPLE.

FIG. 10 is a graph showing the pore (volume) distribution obtained by means of small angle X-ray scattering spectrum of the carbon nanostructure in EXAMPLE.

FIG. 11 is a graph showing the adsorption/desorption curve of the carbon nanostructure in EXAMPLE.

### BEST MODE FOR CARRYING OUT THE INVENTION

Hereinafter, details, other features and advantages of the present invention will be described.

### (Carbon Nanostructure)

The carbon nanostructure is configured such that carbon-containing rod-shaped materials and/or carbon containing sheet-shaped materials are three-dimensionally bound to each other while air-sac-like pores, which are defined by graphene multilayer membrane walls, are formed in the rod-shaped materials and/or the sheet-shaped materials.

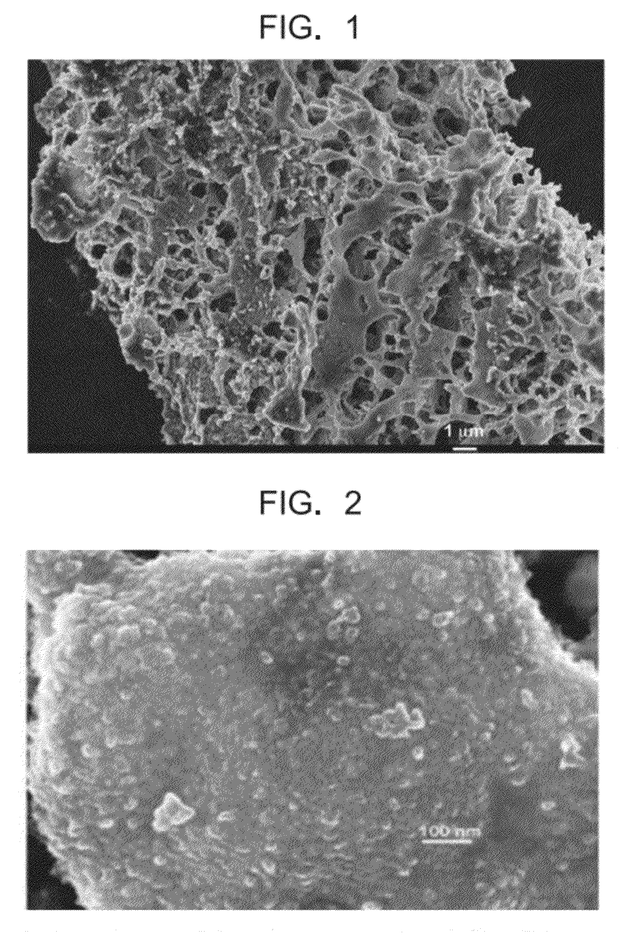

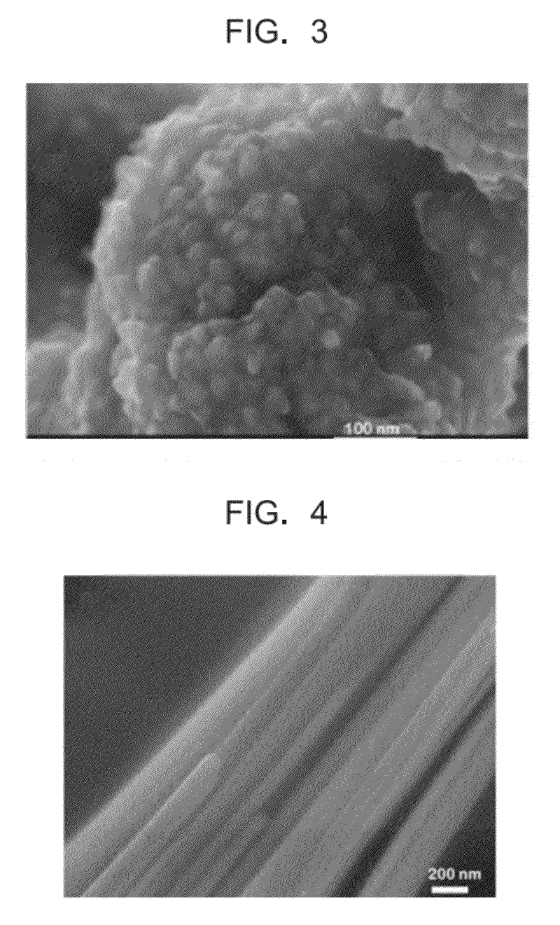

FIG. 1 is a SEM image showing the appearance of a carbon nanostructure according to the present invention, and FIGS. 2 and 3 are SEM images showing the respective enlarged surfaces of the carbon nanostructure in FIG. 1.

The carbon nanostructure shown in FIG. 1 is configured in a shape of wisp of burned and carbonized heavy paper bundle and has many pores in the order of micrometer which are randomly positioned so that rod-shaped materials and/or sheet-shaped materials are bound in a shape of three-dimensional network to each other to form an integrated monolith of network structure. As shown in FIGS. 2 and 3, moreover, the surface of the integrated monolith is covered with hump-shaped protrusions. Such a structural feature is originated from the producing method as will be described below.

Note that the carbon nanostructure shown in FIGS. 1 to 3 is only exemplified and an intended carbon nanostructure can be formed in any shape by appropriately changing the producing method.

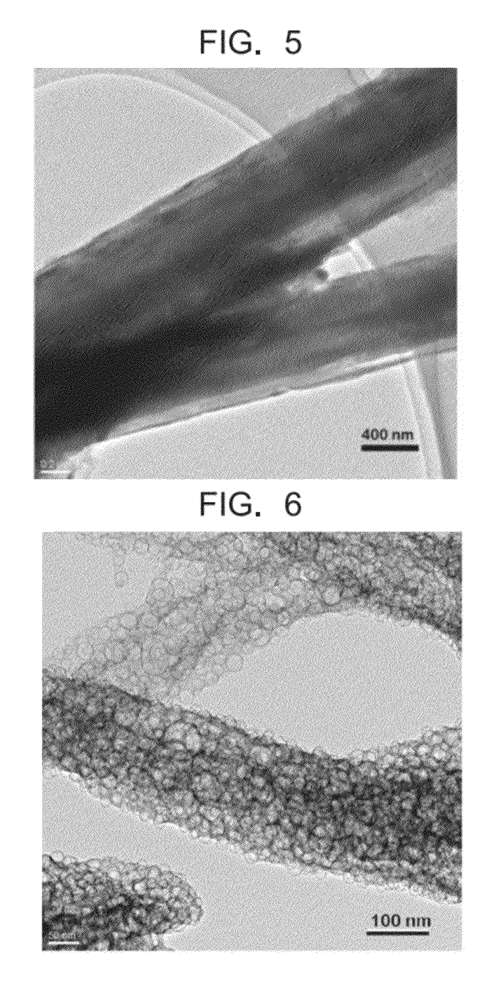

FIGS. 4 and 5 are a SEM and TEM images of the rod-shaped crystalline materials and/or the sheet-shaped crystalline materials made of copper methylacetylide to be used for the production of the carbon nanostructure shown in FIG. 1. It is recognized from FIGS. 4 and 5 that the diameter of each of the rod-shaped materials and the width of each of the sheet-shaped materials are within a range of 100 nm to 10 μm.

FIG. 6 is a TEM image showing a portion of the carbon nanostructure in FIG. 1. As is apparent from FIG. 6, it is recognized that the carbon nanostructure in this embodiment has air-sac-like pores which are defined by the three-layered through ten-layered graphene multilayer membrane walls and are communicated with one another. Moreover, it is recognized that the air-sac-like pores are configured such that some membrane walls of the graphene multilayer membrane walls are branched several times so that some membrane walls defining one pore also defines another pore adjacent to the one pore so that the adjacent pores are communicated with one another.

As is apparent from FIG. 6, furthermore, the pores are normally classified into relatively small pores (first pores) each having a void diameter of a range of 1 nm to 20 nm and located in the vicinity of the superficial skin of the carbon nanostructure and relatively large pores (second pores) each having a void diameter of a range of 10 nm to 80 nm and located in the inner side of the carbon nanostructure.

The carbon nanostructure in this embodiment has a BET specific surface area of 80 m²/g or more, and as the case may be, of 300 m²/g or more, for example. The BET specific surface area depends upon the diameter of each of the rod-shaped materials and sheet-shaped materials, and the diameter of each of the pores included in the carbon nanostructure. For example, the BET specific surface area is increased as the diameter of each of the rod-shaped materials and sheet-shaped materials are decreased and as the diameter of each of the pores included in the carbon nanostructure are decreased.

The distribution of meso space formed by the pores and the network structure of the carbon nanostructure can be recognized by means of a small angle X-ray scattering spectrum.

Next, the producing method of the carbon nanostructure will be described. First of all, a metal encapsulated carbon nanostructure is produced as the precursor of the carbon nanostructure. The metal encapsulated carbon nanostructure may be produced based on the following producing steps, for example.

Acetylene gas or a mixed gas containing methylacetylene gas is blown into a copper (I) chloride-containing ammonia aqueous solution. In this case, the aqueous solution is agitated heavily. Thereby, the yellow precipitates of the rod-shaped crystalline materials and/or the sheet-shaped crystalline materials made of copper methylacetylide are formed in the aqueous solution (refer to FIGS. 4 and 5).

Then, the precipitates are transferred into a larger pressure tight reactor tube made of stainless steel, introduced into a vacuum electric furnace or vacuum high temperature vessel, and heated at a temperature within a range of 90 to 120° C., e.g., for 12 hours or more to conduct the desolvation thereof. In this state, if hydrogen gas is introduced into the pressure tight reactor tube at a pressure of 0.01 kPa or less, preferably 0.001 kPa or more and heated at a temperature of 210 to 250° C. (first heat treatment), methane gas and ethylene gas are generated and carbon materials and copper nanoparticles are precipitated a short while later.

According to the aforementioned heat treatment, a carbon nanostructure intermediate three-dimensionally bound by the rod-shaped materials and/or the sheet shaped materials containing the carbon materials generated by the segregation reaction is produced, and then the metal encapsulated carbon nanostructure encapsulating the copper nanoparticles generated by the segregation reaction in the carbon nanostructure intermediate is produced.

The introduction of the hydrogen gas is to prevent the oxidation of the terminals of the atoms and/or molecules of the carbon materials generated immediately after the reaction. Moreover, if the heat treatment is conducted under an atmosphere of hydrogen gas, the segregation reaction can be conducted at a relatively low temperature and thus the intended metal encapsulated carbon nanostructure can be obtained at the same condition as described above (i.e., low temperature condition). Many voids are formed in the metal encapsulated carbon nanostructure by the gas generation accompanied by the segregation reaction. Therefore, the metal encapsulated carbon nanostructure is formed in a shape of integrated monolith of three-dimensional network structure wound by the rod-shaped materials and/or sheet-shaped materials as shown in FIG. 1.

In this embodiment, in the case of producing the metal encapsulated carbon nanostructure, the copper (I) chloride-containing ammonia aqueous solution is employed and the copper particles are encapsulated in the carbon nanostructure intermediate, which is originated from that the copper(I) chloride can be easily prepared and controlled.

Since the metal encapsulated carbon nanostructure encapsulates the metallic materials, the metal encapsulated carbon nanostructure can exhibit high electric conduction. Therefore, the metal encapsulated carbon nanostructure can be rendered to be functioned as a carbon structure (carbon material) sufficiently satisfying high porosity and high electric conduction. In this point of view, the metal encapsulated carbon nanostructure can be preferably employed as an electrode, a catalyst carrier or the like. In this case, if copper (particles) are encapsulated as described above, the electric conduction of the metal encapsulated carbon nanostructure can be more enhanced.

Then, nitric acid is contacted with the metal encapsulated carbon nanostructure obtained by the aforementioned steps. The contact of the nitric acid is to dissolve the carbon membrane walls encapsulating the metallic materials because the metallic materials are tightly fixed by the carbon membrane walls so that the metallic materials can be easily and perfectly spurted by the second heat treatment as will be described below and the metallic materials do not remain in the voids corresponding to the pores of the carbon nanostructure to be formed later, which the voids are initially formed in the metal encapsulated carbon nanostructure due to the spurt of the metallic materials from the metal encapsulated carbon nanostructure.

In the contact of the metal encapsulated carbon nanostructure with the nitric acid, the metallic materials encapsulated in the metal encapsulated carbon nanostructure are partially dissolved out.

The nitric acid can be appropriately diluted with water so as to be used as a nitric acid aqueous solution. The contact time of the metal encapsulated carbon nanostructure with the nitric acid depends on the concentration of the nitric acid aqueous solution, but is preferably in the order of several ten hours.

Then, the second heat treatment is conducted so as to spurt (sublimate and release) the metallic materials encapsulated in the metal encapsulated carbon nanostructure, thereby obtaining the aforementioned carbon nanostructure. In this case, the voids formed by the spurt of the metallic materials corresponds to the pores of the carbon nanostructure. The second heat treatment is conducted at a temperature within a range of 900 to 1400° C. for several hours, concretely for 5 to 10 hours under vacuum atmosphere, for example.

The second heat treatment allows the membrane walls surrounding the metallic materials to be graphene while the second heat treatment allows some membrane walls of the graphene multilayer membrane walls to be branched so as to form the air-sac-like pores.

The second heat treatment can be conducted by using microwave. In this case, the producing cost of the carbon nanostructure can be reduced in comparison with the producing cost thereof using the heat treatment under the vacuum atmosphere in the second heat treatment.

Through the aforementioned steps can be obtained the carbon nanostructure configured such that the carbon-containing rod-shaped materials and/or the carbon containing sheet-shaped materials are three-dimensionally bound to each other while air-sac-like pores, which are defined by graphene multilayer membrane walls, formed in the rod-shaped materials and/or the sheet-shaped materials.

As is apparent from the aforementioned description, the structural feature that the carbon nanostructure exhibits the integrated monolith of three-dimensional network structure wound by the rod-shaped materials and/or the sheet-shaped materials is originated from the aforementioned producing method, namely, that the metal encapsulated carbon nanostructure as the precursor has the same structural feature as the one of the carbon nanostructure.

After the metallic materials are spurted from the metal encapsulated carbon nanostructure, the metal encapsulated carbon nanostructure may be washed so as to remove the residue of the metallic materials in the voids, that is, the pores to be formed later. As described above, since the air-sac-like pores of the carbon nanostructure are formed from the voids which are formed by spurting the metallic materials from the metal encapsulated carbon nanostructure, if the metallic materials to be spurted remain in the voids of the metal encapsulated carbon nanostructure, that is, the pores of the carbon nanostructure, the residue of the metallic materials may adversely affect the use and characteristics of the carbon nanostructure, depending on the use of the carbon nanostructure.

As described above, however, by washing the metal encapsulated carbon nanostructure so as to remove the residue of the metallic materials remaining in the voids, that is, the pores to be formed, the aforementioned disadvantages can be prevented.

The washing treatment is conducted for 4 to 8 hours by immersing the metal encapsulated carbon nanostructure in nitric acid, for example.

The residue of the metallic materials remaining in the metal encapsulated carbon nanostructure can be removed by the third heat treatment. In this case, if the third heat treatment is conducted at a temperature within a range of 500 to 1400° C., the residual metallic materials can be removed from the carbon nanostructure.

In the case of removing the residual metallic materials in the metal encapsulated carbon nanostructure, the washing treatment and the third heat treatment may be independently employed or combined with one another.

### Example

### Example 1

First of all, ammonia aqueous solution (5.5%) containing 0.1 mol/L copper(I) chloride was prepared in a flask. Then, 10% acetylene gas diluted by nitrogen gas was blown to 200 mL of the ammonia aqueous solution at a rate of 200 mL/min for about 120 minutes from the bottom of the flask while the ammonia aqueous solution was agitated heavily. Thereby, rod-shaped crystalline materials and sheet-shaped crystalline materials of copper methylacetylide started to be formed and precipitated in the ammonium aqueous solution.

Then, the thus obtained precipitates were filtered with a membrane filter while the precipitates were washed with methanol during the filtration thereof. If the reaction time is elongated, the size of each of the precipitates can be enlarged up to several hundred micrometers. The aforementioned steps were repeated six times and then 50 g of yellow wire-shaped crystalline hydrated precipitates was obtained.

Then, 50 g of the precipitates was put into a small thick-walled beaker of 300 ml, and then put into a large thick-walled beaker of 3 L. The openings of the small and large thick-walled beakers were sealed with four rids made of tetrafluoroethylene. The thickness of each of the rids is 10 mm. Minute air vent holes are formed at the respective four rids. The openings of the thick-walled beakers were sealed with the four rids so that the minute air vent holes of the four rids are not closed up one another. The sealed beakers were put into a vacuum container made of stainless steel and having an inner diameter of 155 mm, a length of 300 mm and a thick wall of 5 mm. Thereafter, the interior of the vacuum container was depressurized up to 100 Pa or less. In this state, 1 L of hydrogen gas was introduced into the vacuum container so that the temperature of the vacuum container was heated to a temperature of 250° C. during 30 minutes under a pressure of 0.3 atom.

In this case, the pressure of the interior of the vacuum container was gradually increased, but sharply increased up to a little over one atom after 2 to 3 hours. Then, the vacuum container was cooled down to obtain about 20 g of metal encapsulated carbon nanostructure.

Then, 20 g of the metal encapsulated carbon nanostructure was put into a conical flask of 1 L and 400 mL of 30 to 40 mass % nitric acid aqueous solution was added in the conical flask. In this case, the metal encapsulated carbon nanostructure was shrunk while red-brown nitrogen dioxide gas was generated from the metal encapsulated carbon nanostructure. Moreover, the residual copper in the metal encapsulated carbon nanostructure was dissolved. The vacuum container was heated to a temperature of 60° C. for about 30 to 48 hours so as to enhance the dissolution of the residual copper and oxidize unstable carbon atoms and/or molecules.

The thus obtained carbon nanostructure was filtered, washed and dried sufficiently, and input into a quartz tube so as to be heated at a temperature of 1100° C. for about 12 hours under a vacuum atmosphere. In this case, organic thin films were deposited on the lower temperature wall at the bottom of the quartz tube through sublimation and then copper was deposited on the same portion through sublimation. Only the carbon component was taken out from the quartz tube, and the residual copper was dissolved by hot nitric acid. The carbon component was dried, put into a Tammann tube made of alumina and heated at a temperature of 1400° C. for 10 hours.

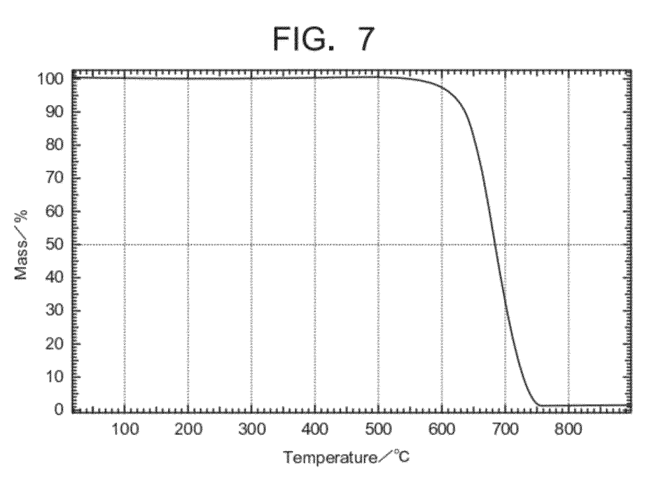

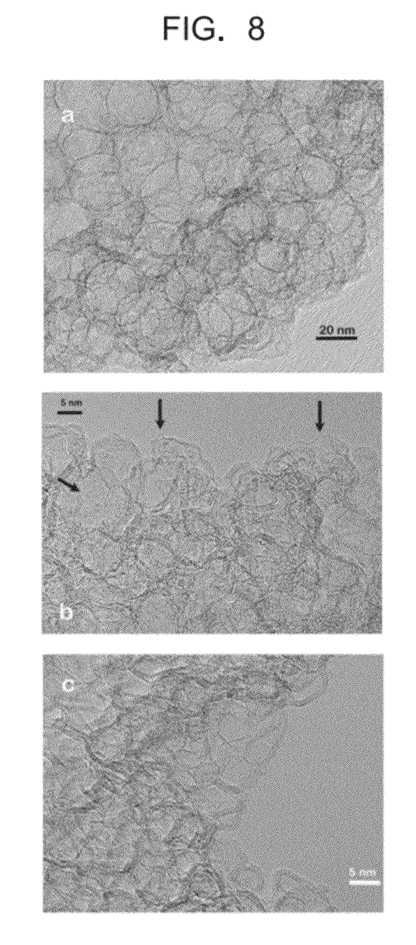

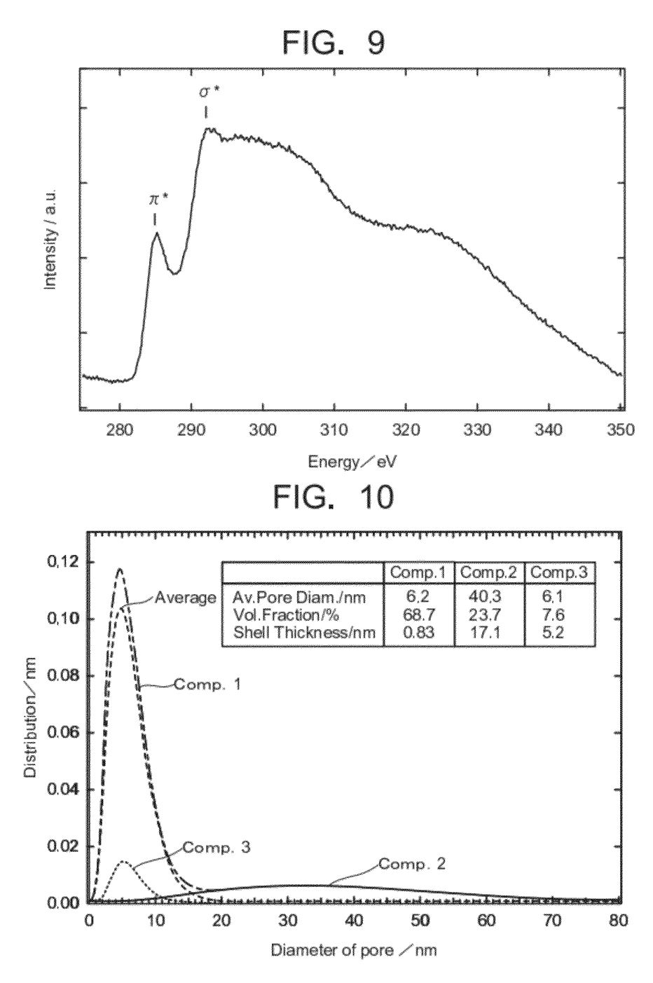

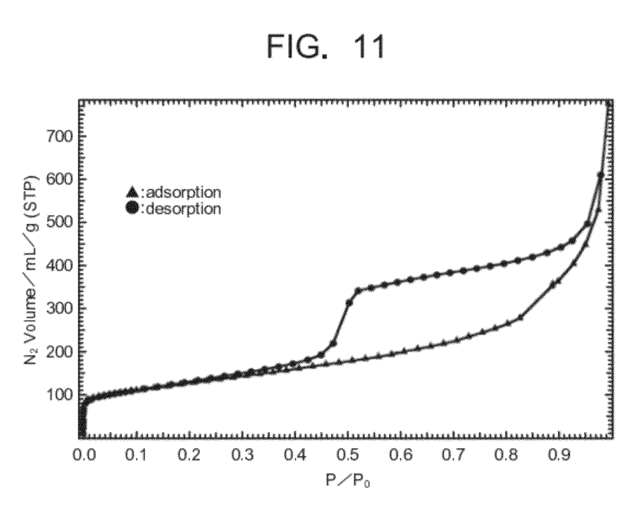

The thus obtained carbon material was examined by TGA (thermogravimetric measurement). FIG. 7 is a graph showing the result in TGA (thermogravimetric analysis) of the carbon nanostructure. The graph indicates that the combustion temperature of the carbon nanostructure is 680° C. which is similar to the one of graphite and the amount of the residual copper is 2 mass % or less. FIG. 8 is a TEM image showing the carbon nanostructure. FIG. 9 is a graph showing the electron energy loss spectrum of the carbon nanostructure. FIG. 10 is a graph showing the void (volume) distribution obtained by means of small angle X-ray scattering spectrum of the carbon nanostructure. FIG. 11 is a graph showing the adsorption/desorption curve of the carbon nanostructure. The BET specific surface area of the carbon nanostructure was 300 m²/g referring to the data shown in FIG. 11. It is recognized from the graph shown in FIG. 10 that a large amount of smaller pores each having a size of about 6 nm are formed in the superficial skin of the carbon nanostructure (Comp. 1 and 3), and a large amount of larger pores each having a size of about 40 nm are formed in the inner side of the carbon nanostructure (Comp. 2).

### Example 2

In Example 1, the metal encapsulated carbon nanostructure encapsulating copper particles was treated with nitric acid so as to remove the copper particles and enlarge the void combination portions. In this Example, the heat treatment using microwave was conducted instead of the heat treatment using vacuum heating process of 1100° C. The heating period of time was set to less than 2 hours. In the nitric treatment, adjacent pores were combined with one another to form large pores with an average diameter of 40 nm.

Although the present invention was described in detail with reference to the above examples, this invention is not limited to the above disclosure and every kind of variation and modification may be made without departing from the scope of the present invention.

What is claimed is:

1. A carbon nanostructure comprising:
carbon containing rod-shaped materials and/or carbon containing sheet-shaped materials which are bound three-dimensionally; and
graphene multilayer membrane walls which are formed in the rod-shaped materials and/or the sheet-shaped materials,
wherein air-sac-like pores, which are defined by the graphene multilayer membrane walls, are formed in the rod-shaped materials and/or the sheet-shaped materials.

2. The carbon nanostructure as set forth in claim 1,
wherein the rod-shaped materials and/or the sheet-shaped materials are configured as an integrated monolith of three-dimensional network structure.

3. The carbon nanostructure as set forth in claim 1,
wherein a diameter of each of the rod-shaped materials and a width of each of the sheet-shaped materials are within a range of 100 nm to 10 μm, respectively.

4. The carbon nanostructure as set forth in claim 1,
wherein the air-sac-like pores are classified into first pores each having a void diameter of 1 nm to 20 nm and second pores each having a void diameter of 10 nm to 80 nm.

5. The carbon nanostructure as set forth in claim 1, further comprising a BET specific surface area of 80 m²/g or more.

6. The carbon nanostructure as set forth in claim 5, further comprising a BET specific surface area of 300 m²/g or more.
